(19) United States
(12) Patent Application Publication
(10) Pub. No.: US 2016/0307470 A1
(43) Pub. Date: Oct. 20, 2016

(54) SYSTEM AND METHOD FOR DYNAMIC GEOMETRY SUGGESTION TOOL

(71) Applicant: BrainPOP, New York, NY (US)

(72) Inventors: Eyal INBAR, Tel Aviv (IL); Alon NEUFELD, Qiryat Ono (IL)

(21) Appl. No.: 14/687,641

(22) Filed: Apr. 15, 2015

(51) Int. Cl. G09B 23/04; G06F 3/0484; G06F 3/0481

(52) U.S. Cl. CPC G09B 23/04; G06F 3/04817; G06F 3/04842; G06F 3/04845

(57) ABSTRACT

A system or method may include a processor and a graphical user interface to receive input relating to one or more shape objects. The processor may generate a shape object based on the received input. The processor may further calculate one or more relationships between the generated shape object and at least one previously displayed shape object. The processor may determine whether the one or more calculated relationships match a defined geometrical dependency. If the processor determines that a match exists, an icon associated with the matched geometrical dependency may be displayed.

### FIELD OF THE PRESENT INVENTION

The present invention relates to dynamic geometry applications, geometry software, educational software, and digital construction tools.

### BACKGROUND

Many software applications exist for drawing figures, such as Microsoft PowerPoint, Apple Keynote, Google Slides, Adobe Photoshop, and Microsoft Visio. These applications may allow a user to select a variety of pre-defined shapes and designate attributes such as size, length, radius, or other appropriate attributes for the particular type of shape. Different shapes added to a figure or drawing may be aligned with other shapes that were previously placed in the figure. Alignment between shapes may occur through user action, or the application may offer suggestions for automatic alignment of a new shape with existing shapes. For example, when a user places a new shape (e.g., a triangle) near an existing shape (e.g., an ellipse), a geometry or drawing application may display a thin line near the closest intersection points between the shapes, indicating that the user can align the new shape with the existing shape. The application's suggestion may guide the user to “snap” the new shape into a position that is aligned with a grid or the existing shape.

In some applications, users may configure new shapes to have particular dependencies or relationships with existing shapes. The dependencies may include alignment or other characteristics, such as a perpendicular dependency with an existing shape's edge, or maintaining a fixed size ratio as compared to an existing shape (e.g., a half, or a third). However, users may find that configuring each new shape requires multiple steps or is time-consuming. Further, some geometry or drawing applications may not maintain a designated dependency between shapes if a user changes one of the shapes' characteristics (e.g., size, length, radius). Users may find that re-configuring dependencies between changed shapes may also be time-consuming and complicated.

For students learning geometry, a visual tool such as a drawing tool may be helpful in illustrating geometrical relationships and theorems. Students of geometry may desire a drawing tool that efficiently constructs common geometrical relationships, without requiring multiple configuration steps.

### SUMMARY

A system or method may include a processor and a graphical user interface to receive input relating to one or more shape objects. The processor may generate a shape object based on the received input. The processor may further calculate one or more relationships between the generated shape object and at least one previously displayed shape object. The processor may determine whether the one or more calculated relationships match a defined geometrical dependency. If the processor determines that a match exists, an icon associated with the defined geometrical dependency may be displayed.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a high level block diagram of a dynamic geometry suggestion system according to embodiments of the present invention;

FIG. 2 is an illustration of a method for generating angle construction types, according to embodiments of the invention;

FIG. 3 is an illustration of handling more than one match of construction types, according to embodiments of the invention;

FIG. 4 is an illustration of inscribed and circumscribed construction types, according to embodiments of the invention;

FIG. 5 is an illustration of maintaining geometric dependencies, according to embodiments of the invention; and

FIG. 6 is a flowchart of a method, according to embodiments of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION

In the following description, various aspects of the present invention will be described. For purposes of explanation, specific configurations and details are set forth in order to provide a thorough understanding of the present invention. However, it will also be apparent to one skilled in the art that the present invention may be practiced without the specific details presented herein. Furthermore, well known features may be omitted or simplified in order not to obscure the present invention.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulates and/or transforms data represented as physical, such as electronic, quantities within the computing system's registers and/or memories into other data similarly represented as physical quantities within the computing system's memories, registers or other such information storage, transmission or display devices.

Embodiments of the invention may provide a system or method of digitally constructing shapes that depend on or relate to other shapes. The relationship or dependencies between constructed shapes may describe common relationships used in geometry rules or theorems. For example, common relationships between lines or between a line and an edge of a shape may be parallel or perpendicular. Another relationship between a line and an angle (e.g., two other lines) may be bisection, or an angle relationship between lines may be an angle of 30, 45, 60, or 90 degrees. Other relationships may be a circle inscribed within a triangle, or a circle circumscribing a square. These common relationships may be referred to as construction types.

Embodiments of the invention may suggest or infer these construction types as a user constructs or generates shape objects in a drawing. The construction types may be suggested even if a user's placement of shapes in a drawing does not exactly illustrate the common geometrical relationship described by the construction type. The suggestion of construction types, as a displayed icon or picture on a computer, for example, may aid a geometry student to visualize the common relationships found in geometry theorems. Instead of requiring the student to configure a shape before selecting or drawing it, which may involve setting a complex set of parameters, educational software including embodiments of the invention may allow a student to generate a shape object and select a suggested construction type, based on the relationship between the generated shape object and existing shapes in the drawing. As a result, embodiments of the invention may provide a more intuitive tool to teaching geometrical relationships.

Each construction type or geometric dependency may be defined by a set of one or more specific geometric relationships or relationships between shapes. In general, geometric dependencies may describe a characteristic of a shape object relative to an existing shape object (such as a position or distance relative to an existing shape object, or an intersection with an existing shape object). For example, a geometric dependency describing an angle of 45 degrees may be defined by a first relationship where a new line includes a starting point on an existing line and a second relationship where an angle created between the lines is 45 degrees. The second relationship may be calculated by the formula tan⁻¹ {(m1−m2)/(1+m1*m2)}, where m1 and m2 are the slopes of two lines. Other geometry formulas as known in the art may be used to calculated geometrical dependencies and relationships. Calculated relationships may be Boolean values satisfying a condition such as the first relationship, or may be numerical values, such as the second relationship. Geometrical dependencies may be defined by a set of any number of one or more relationships.

Shapes or shape objects may be generated on a digital drawing or canvas that keeps track of a shape object's position (e.g., x-y coordinates) within the drawing. A shape or shape object constructed by embodiments of the invention may be a point, line, arc, circle, ellipse, triangle, square, polygon, or any combination of curves, lines, and points. Shapes may be represented by a set of one or more points that make up the combination of curves, points, and other lines. A shape object may be represented by a data structure that defines a type of shape and defines values of the shape type's attributes within a drawing (e.g., slope, length, radius, position). The attributes of a shape type may be different for each type. For example, a circle type shape object may be defined by a radius and center point, an ellipse type shape object may be defined by a center point, major axis, and minor axis, and a square may be defined by a side length and a center point. Other types of shape objects may be defined. A shape or geometry data structure may determine the set of points that define a shape object depending on the type's attributes and value. For example, a circle type shape with a center (a, b) and radius r attributes may be defined by the equation (x−a)²+(y−b)²=r².

Each new digital drawing provided by software or an application may be initially blank, for example. A user may initially generate a first shape object, such as a line, circle or polygon, and the first shape object may be initially displayed within the digital drawing. The user may input variables or click on buttons on a graphical user interface to describe the attributes of the shape objects. The user may generate, via the graphical user interface, a second shape object, and relationships between the second generated shape object and the existing or previously displayed first shape object may be calculated. If the calculated relationships match one of the defined geometric dependencies, the geometric dependency may be displayed to a user as an icon, or other image, for example. The icon may suggest the construction type or geometric dependency to the user, and the user may have the option to select the construction type by, for example, clicking on the displayed icon. By selecting the geometric dependency, the software may adjust the new, generated shape so that the generated shape and the existing shape exhibits the relationships defined by the geometric dependency. The user may have the option of not selecting the icon, by clicking elsewhere in the drawing. By not selecting the icon, the shape objects may be “free” from each other, or may have no geometrical dependency between them.

While embodiments of the invention may refer primarily to two-dimensional shapes and dependencies, methods and systems as described herein may also apply to three-dimensional or n-dimensional shapes and dependencies (e.g., a plane intersecting a cone).

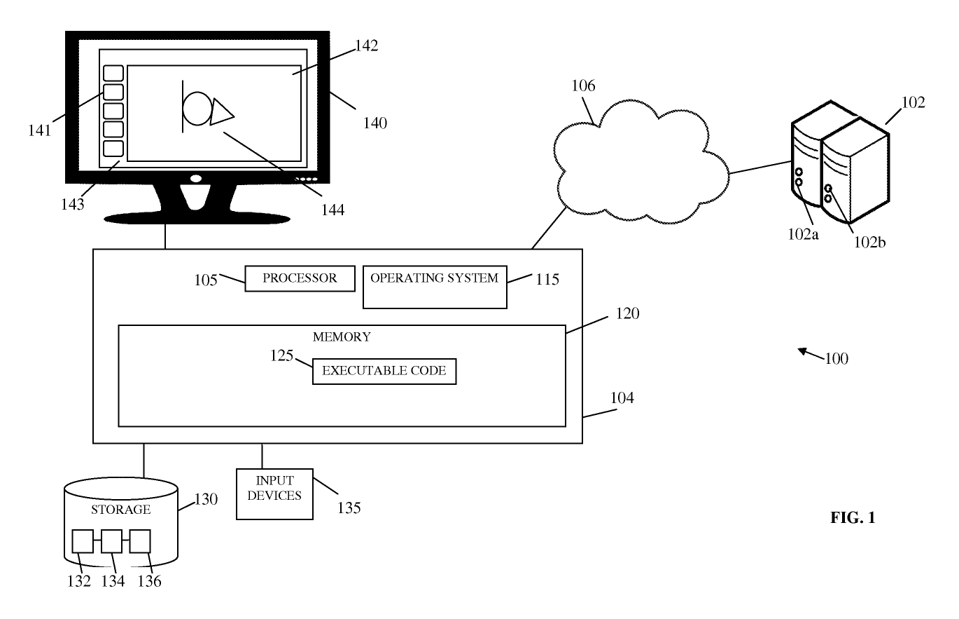

FIG. 1 is a high level block diagram of a dynamic geometry suggestion system 100 according to embodiments of the present invention. A computing device 104 may include and execute software or an application that allows a user to generate a plurality of shapes and suggest geometric dependencies that place the shapes relative to each other according to common geometrical relationships.

Computing device 104 may include a processor 105 that may be, for example, a central processing unit processor (CPU), a chip or any suitable computing or computational device, an operating system 115, a memory 120, a storage 130, an input devices 135 and an output devices 140.

Operating system 115 may be or may include any code segment designed and/or configured to perform tasks involving coordination, scheduling, arbitration, supervising, controlling or otherwise managing operation of computing device 200, for example, scheduling execution of programs. Operating system 115 may be a commercial operating system. Memory 120 may be or may include, for example, a Random Access Memory (RAM), a read only memory (ROM), a Dynamic RAM (DRAM), a Synchronous DRAM (SD-RAM), a double data rate (DDR) memory chip, a Flash memory, a volatile memory, a non-volatile memory, a cache memory, a buffer, a short term memory unit, a long term memory unit, or other suitable memory units or storage units. Memory 120 may be or may include a plurality of different memory units.

Executable code 125 may be any executable code, e.g., an application, a program, a process, task or script. Executable code 125 may implement educational software or a type of drafting application such as computer aided design (CAD), for example. Executable code 125 may be executed by processor 105 possibly under control of operating system 115. Executable code 125 may perform steps to define a construction type or geometric dependency by a set of one or more relationships, or calculate one or more relationships between a generated shape object and an existing or previously displayed shape object. In some embodiments, more than one computing device 104 may be used. Controller or processor 105 may, for example, be configured to carry out all or part of the present invention by for example executing software or code such as code 125. For example, processor 105 may determine whether the one or more calculated geometric dependencies match the defined construction type within a proximity, and if a match is determined within the proximity, displaying the defined construction type.

Storage 130 may be or may include, for example, a hard disk drive, a floppy disk drive, a Compact Disk (CD) drive, a CD-Recordable (CD-R) drive, a universal serial bus (USB) device, a Digital Video Disc (DVD) drive, cloud/internet based storage, or other suitable removable and/or fixed storage unit. Data may be stored in storage 130 and may be loaded from storage 130 into memory 120 where it may be processed by processor 105. For example, storage 130 may store a plurality of defined geometric dependencies 132 as a plurality of sets of relationships 134 and associated proximity conditions 136 for each defined geometric dependency. The plurality of geometric dependencies may be stored as a table, hash table, linked list, XML table, global variables, a tree, or other data structures, for example. The sets of relationships 134 and associated proximity conditions 136 may be modified or re-configured by an administrator, for example.

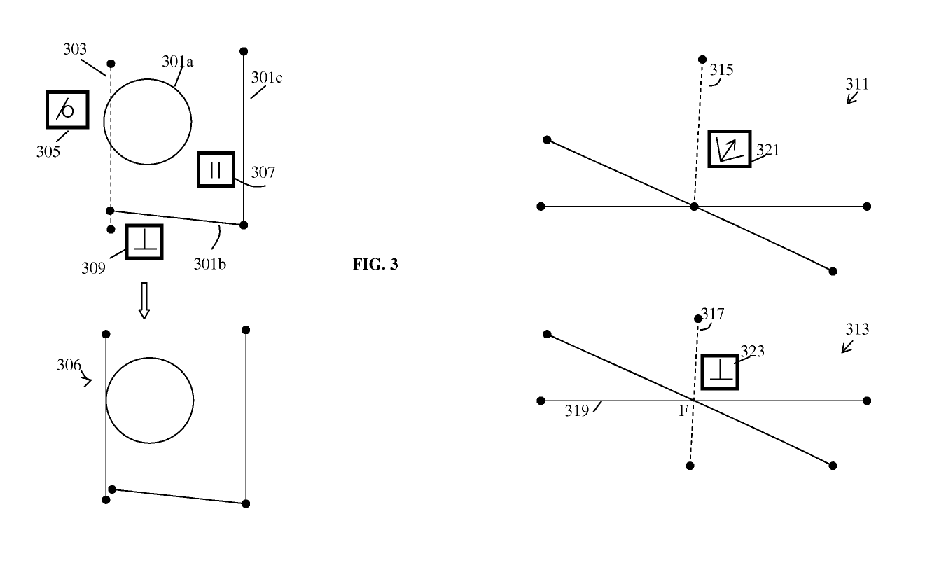

Storage 130 may further store a pre-set group of shape objects that may be selected by a user in a drawing. The shape objects may include, for example, a line, a circle, a square, a point, a rectangle, or any other polygon. The shape objects may be described by certain parameters so that they can be easily rendered onto a drawing application. For example, a square shape object may be described by a side length, and a circle may be described by a radius. A drawing application implementing embodiments of the invention may be able to quickly generate a square object using only a side length and the characteristics of a square, e.g. a shape having four equal side lengths and four right angles. Other tables describing a priority of geometric dependencies to be displayed (see FIG. 3) may also be stored in storage 130.

In some embodiments, for example, memory 120 may be a non-volatile memory having the storage capacity of storage 130. Accordingly, although shown as a separate component, storage 130 may be embedded or included in memory 120. Memory 120 may for example, store and keep track of geometrical dependencies and relationships in a drawing. In order to compare the calculated relationships to a plurality of geometric dependencies defined by a set of relationships, memory 120 may also store, in RAM, a set of important geometrical dependencies.

Input devices 135 may be or may include a mouse, a keyboard, a touch screen or pad or any suitable input device. It will be recognized that any suitable number of input devices may be operatively connected to computing device 200 as shown by block 135. For generating shape objects and selecting suggested geometric dependencies for example, users may typically use a mouse or a touch screen to manipulate elements 141 on a graphical user interface 143. Users may also decline to select a displayed geometric dependency by using a mouse to click elsewhere in a drawing canvas 142, for example.

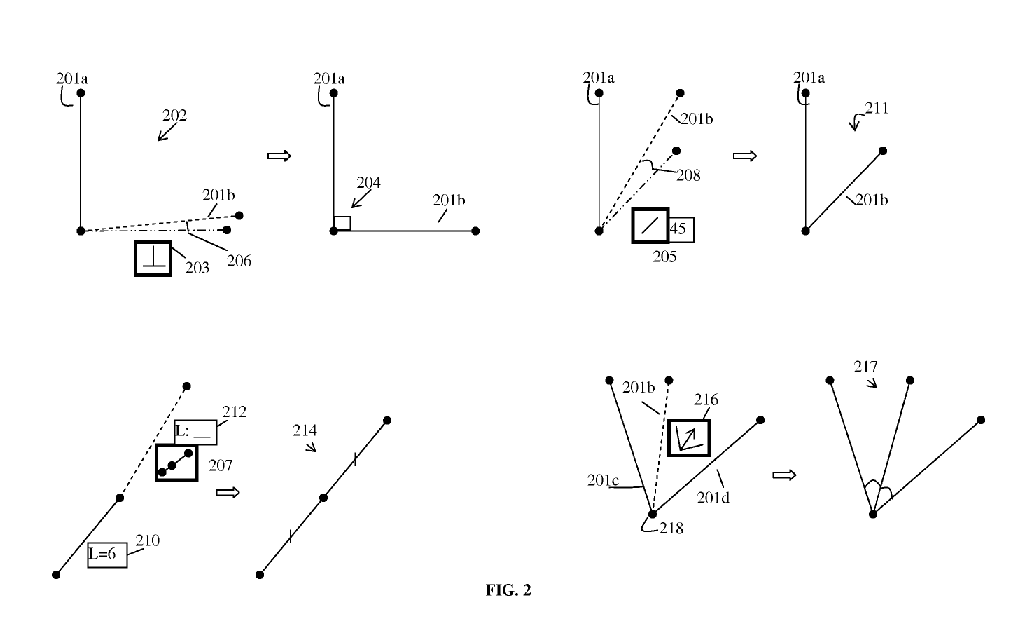

Output devices such as a computer monitor 140 may include one or more displays, or any other suitable output devices. For touch screens, such as on smart phones or tablets, for example, computer monitor or display 140 and input device 135 may be integrated. Computer monitor 104 may display a graphical user interface (GUI) 143 of the software application described herein. For example, the GUI 143 may include a drawing canvas 142, where users may select and generate shape objects 144 by clicking on or touching on-scream buttons 141. The GUI 143 may further allow selection of suggested geometric dependencies, according to embodiments of the invention. More illustrations of shape objects created or generated using a graphical user interface 143 may be found at FIGS. 2-6.

Computer device 104 may implement a software application is stored and executed on local storage and hardware, or the software application may be stored remotely on a server 102, for example, and accessed through a network 106 such as the Internet or web. Server 102 may include a processor 102a and memory 102b similar to memory 120 and processor 105.

Embodiments of the invention may include an article such as a computer or processor non-transitory readable medium, or a computer or processor non-transitory storage medium, such as for example a memory, a disk drive, or a USB flash memory, encoding, including or storing instructions, e.g., computer-executable instructions, which, when executed by a processor or controller, carry out methods disclosed herein. For example, a storage medium such as memory 120, computer-executable instructions such as executable code 125 and a processor such as processor 105.

While in one embodiment processors 105 and 102a are described as performing certain functionality, in other embodiments, multiple, distributed or different processors, or processors having different structures, may be used. Modules and systems described herein, such as a secure hardware module, a system for enrolling signatures, and other modules, may be or may have their functionality performed by processors 105 and 102a. Processor(s) 105 and 102a may include one or more processors (of the same or different type) may be part of a larger computing system 101, e.g., a system that suggests and displays construction types. Processors 105 and 102a may be configured to perform embodiments or steps described herein for example by executing software or encoded instructions. Dedicated processors (e.g., video or graphics chips) or dedicated processor areas may be used or may be included as part of processor(s) 105 and 102a, and such processors may be configured to perform such tasks for example by dedicated circuitry or by executing software. Server 102 may also be configured to perform steps described herein by including processors within those devices or by executing software or encoded instructions. Memory, such as memory 120 and 102b, may be configured to store data used as discussed herein such as images for comparison or analysis, such as reference images and video images, by storing them in hard drives, random access memory, or databases for example. Memory 120 and 102b may be configured to store executable software or encoded instructions that are accessible by processor 10 or other processors.

FIG. 2 is an illustration of a method for generating angle construction types, according to embodiments of the invention. As used herein, construction types and geometric dependencies may be used interchangeably to mean a defined or predefined set of relationships between shapes, such as an angle, an intersection, or distance, for example, that are commonly described in geometry. In general, relationships may be calculated after a first shape object 201a is generated (e.g., by a user or as an initial condition) and when a second generated shape object is drawn 201b (by a user manipulating an input device such as a mouse). A relationship may be a Boolean condition with a true or false value or a measurement with a numerical value. For a right angle construction type 203, where an angle between two lines is 90°, the set of relationships defining it may include i) a Boolean condition that a generated line object 201b intersects an existing line object 201a and ii) a calculated angle of 90° formed by the intersection. Other relationships may be defined for the right angle construction type 203. A proximity threshold may be assigned to the right angle construction type 203 that indicates the level of tolerance or error allowed for a set of relationships to be considered a match. The proximity threshold may be more typically applied to relationship conditions that have numerical values. For example, right angle construction type 203 may have a proximity of ±5°. This allows geometric relationships calculated to have 85°-95° angles to be considered a match, within the assigned proximity, of the right angle construction type 203. Proximity values or proximity thresholds may be a numerical error or tolerance, or may be a percentage error.

When a new line object 201b is initially drawn (shown as a dotted line), relationships may be calculated between the generated or new line object 201b and one or more previously displayed shape objects, such as line object 201a. The calculations may occur immediately, regardless of whether the relationships match a defined construction type. In the initial drawing 202, the relationships calculated may include determining that the generated line object 201b intersects previously displayed line object 201a and determining that the acute angle between the lines is 85°. Since 85° is within the proximity 206 of a 90 angle, the relationships calculated between the generated line object 201b and the existing line object 201a may be determined a match with the right angle construction type. The right angle construction type 203 may be displayed (e.g., on computer monitor 140) in the vicinity or neighborhood of the generated line object 201b. The right angle construction type 203 may be an icon with a symbol that suggests to a user that a right angle may be constructed or drawn. If the user selects the displayed construction type, by clicking on it with a mouse cursor for example, the generated line object may be adjusted 204 or modified by the software application, so that the new line object 201b forms a right angle 204 with the existing line object 201a.

In another example, a 45° degree angle construction type 205 may be defined by the following set of relationships: i) an intersection of lines and ii) an angle formed between lines of 45°. The construction type 205 may further be assigned or associated with a proximity value of ±15%. A generated line object 201b and an existing line object 201a may have a calculated angle of 39°. Since the relationship between generated line object 201b and existing line object 201a, e.g., calculated angle of 39° is within the 15% proximity 208 of the construction type's definition, the software or drawing application may determine that a match between the calculated relationship in the objects drawn and the 45° angle construction type. The icon or image associated with the 45° angle construction type may be displayed near the generated line object 201b. If a user selects the icon, the generated line object 201b may be adjusted 211 to match the relationship conditions defining the 45° angle construction type. A text box 205a may be optionally displayed to further explain the meaning of the icon.

Other types of suggested parameters may be displayed to a user besides a construction type. For example, an extended, congruent line segment may be constructed by determining that calculated geometric dependencies match an extended line segment construction type 207 within an assigned or associated proximity A text box or tool tip 210 may appear near the existing line object 201a indicating the length of the line. In addition to the displayed construction type 207, an input text box 212 may also be displayed, allowing the user to input a length for generated line object 201b. If, for example, a user inputs a “6” into the input text box and selects the construction type 207, the generated line object 201b may be adjusted or modified so that it extends the existing line object 201a with a congruent length 214. Other types of input text boxes may be possible, such as an input box that sets a specific angle value between lines.

Relationships between a generated shape or line object 201b and more than one existing line object 201c and 201d may be calculated. For example, as line object 201b is generated by a user, two angles may be calculated: an angle between line object 201b and 201c and an angle between line object 201b and 201d. Further, two intersections (e.g., at vertex 218) may be determined as true. An angle bisection construction type 216 may be defined as i) a condition of having a generated line object 201b sharing an endpoint with two existing line objects, and ii) two equal angles formed between generated line object 201b and existing line objects. The angle bisection construction type 216 may be associated with a proximity of 5° for the second relationship condition (e.g., two angles are within 5° of each other). Since the angles may be calculated as 30° and 35°, which match the angle bisection construction type 216 within the assigned proximity, the icon for angle bisection may be displayed. If a user selects the icon, generated line object 201b may be adjusted 217 so that it bisects the angle previously formed by existing line objects 201c and 201d.

FIG. 3 is an illustration of handling more than one match of construction types, according to embodiments of the invention. A plurality of construction types may be defined, each have a unique set of relationships (some construction types may overlap in relationship conditions, such as the presence of an intersection). Each of the construction types may further be associated with a proximity threshold. In some cases, more than one construction type may match calculated relationships in a drawing within a respective proximity associated with a particular construction type. For example, a drawing may include three existing shape objects: circle object 301a, line object 301b and line object 301c. For a new generated shape object, such as line object 303, several relationships may be calculated in the drawing: i) line object 303 may intersect circle 301a at two points d distance apart ii) line object 303 may intersect with existing line object 301b iii) line object 303 may form an acute angle with existing line object 301b of 86, iv) line object 303 may have the same slope as existing line object 301c. Other relationships or relationship conditions may be calculated between generated or current line object 303 and existing shape objects. The four described relationships calculated in the drawing may match three construction types within their respective proximities: a tangent construction type 305, a parallel construction type 307, and a right angle construction type 309. The tangent construction type 305, for example, may be assigned a proximity value of d where a line must be less than d distance away from the edge of a circle. The proximity value assigned the right angle construction type 309 may be a value of e, where an angle formed must be less than e degrees away from 90°. The drawing application may be configured to display or suggest all three construction types. However, a user may only select one of the construction types, since it may not be possible to adjust the new line object 303 to satisfy the geometric dependence conditions of all three construction types. If a user selected the tangent construction type 305, for example, line object 303 may be adjusted so that it is tangent to circle object 301a, as shown in drawing 306.

In some embodiments, it may not make sense from a UI design perspective to display all matching construction types, even if more than one match is determined within respective proximity thresholds of respective construction types. Displaying too many construction types may confuse a user, and it may be best to display construction types based on a predetermined priority order. The priorities may be based on the geometric dependencies calculated within the drawing. For example, in both drawing 311 and 313, the geometric dependencies may match both an angle bisection construction type within proximity p and a right angle construction type q. While both drawing 311 and 313 have the same existing shape objects, the generated line object 315 in drawing 311 shares a starting point with intersection point F, and generated line object 317 in drawing 313 intersects intersection point F. However, in drawing 311, users creating line object 315 from intersection F may be more likely to intend an angle bisection construction than a right angle construction. In drawing 313, users creating or drawing line object 317 to intersect existing line object 319 may be more likely to intend a right angle with existing line object 319 than an angle bisection. Based on the geometric dependencies calculated in drawing 311, the drawing application may prioritize the display of the angle bisection construction type 321. In drawing 313, the display of the right angle construction type 323 may be prioritized. As described, a priority order may be configured based on user interface principles, usability studies, and the geometric relationships calculated within a drawing.

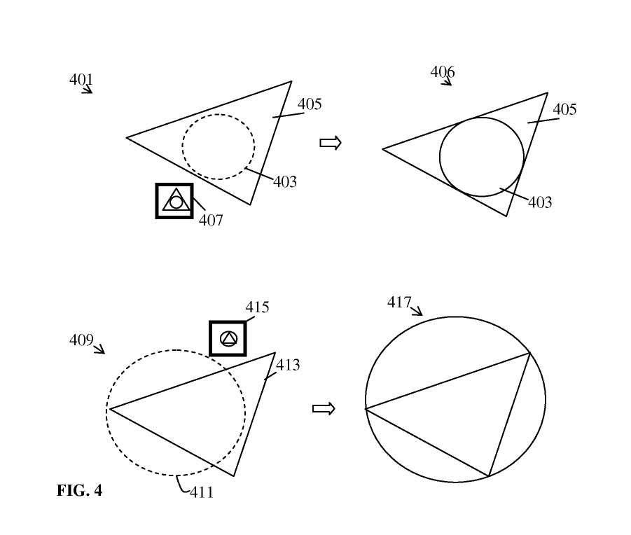

FIG. 4 is an illustration of inscribed and circumscribed construction types, according to embodiments of the invention. Proximities may be defined as conditions as well as values, or a combination or set of conditions and values. Previously, in FIGS. 2-3 for example, matches were determined if calculated relationships matched a set of relationships that defined a construction type, within specified proximity thresholds or values. In some cases, a match may be determined if a set of proximity conditions and values are met.

An inscribed construction type may be defined by a circle object that is tangent to three sides of a triangle. The proximity value or condition assigned or associated with the inscribed construction type may be that one or more edges of a triangle object must be with a distance g of a circle's edge and that the circle must be drawn in the interior of the triangle. Other proximity values and conditions may be configured for the inscribed construction type. As shown in drawing 401, a circle object 403 may be generated by a user and may be drawn to be completely within an existing triangle object 405. The generated circle object 403 may further be within a distance g of the existing triangle object 405. These calculated geometric dependencies may match an inscribed construction type 407, which is displayed to a user as an icon. If the user selects the construction type displayed, the circle object may be adjusted or modified 406 so that it is inscribed within triangle object 405. The inscribed construction type may be determined to be a match of the drawing's geometric dependencies even if the order that the shapes were generated were reversed. For example, if circle object 403 were an existing object and triangle object 405 were a new, generated object, the inscribed construction type 407 may still be displayed. When the user selects the inscribed construction type 407, the triangle object 405, instead of the circle object 403 may be modified or adjusted to match the construction type.

A circumscribed construction type may be defined as a circle intersecting three points of a triangle. The circumscribed construction type may be associated with a proximity condition where a circle intersects a triangle on at least two different sides. The proximity condition may also require that a circle have a percentage h of area lying external to a triangle object. Other proximity values or conditions may be configured or defined. As shown in drawing 409, a generated circle object 411 may meet the proximity conditions and values relative to existing triangle object 413, and a circumscribed construction type 415 may be suggested to the user. If the user selects the circumscribed construction type 415, the generated circle object 411 may be adjusted 417 to intersect the three vertices of a triangle.

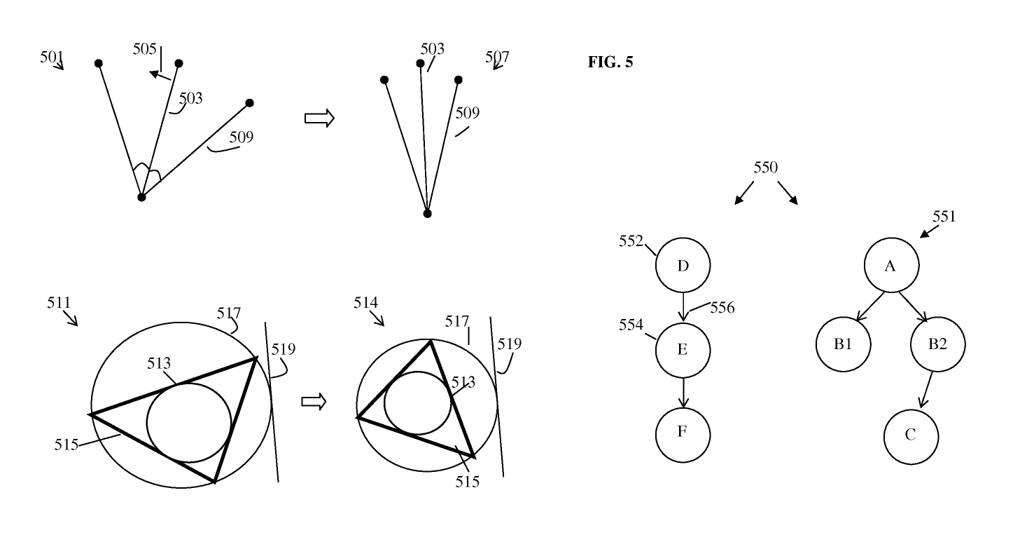

FIG. 5 is an illustration of maintaining geometric dependencies, according to embodiments of the invention. Once a construction type or geometric dependency has been selected by a user, the relationships defining the construction type may be locked as constraints between the shapes, even if the shapes are later modified or edited. For example, if a bisection angle construction type is selected in drawing 501, the dependencies defining the bisection angle construction type may be maintained or conserved, even if line object 503 is modified in a direction described by arrow 505. The other line object 509 may be modified in order to maintain the bisected angle as shown in drawing 507.

Multiple construction types may be maintained or conserved, depending on the order that shape objects are generated and selected in a drawing. The shape objects in the drawings and the geometrical dependencies between them may be stored in a logical tree structure 550, where each node of a tree represents an existing shape object that may be a “parent” node 552 to “child” nodes 554 representing new shape objects generated after the existing shape object. New shape objects may be added to the tree 550 as children to existing shape objects, where new shape objects may depend on existing shape objects, but not vice versa. For example, a line object E may be generated after line object D, and a user may select a geometrical dependency between them, such as a right angle geometrical dependency. If a user edits or modifies line object D to have a different slope, for example, line object E may also change to have a slope perpendicular to line object D, in order to maintain or preserve the right angle geometric dependency (represented as edge 556) between them. However, line object D may not be changed if line object E were modified, due to the direction of the dependency as represented by the tree structure. The same relationships and dependencies may exist between shape object F and line object D.

Other ways of maintaining or conserving geometric dependencies may be possible. For example, an existing shape object of node A may be a parent to two newer shape objects of nodes B1 and B2. In drawing 511, a user may first generate a triangle object 515, which may be represented as node A 558. Two new shapes, circle object 513 and circle object 517 may be generated later, and circle object 513 may be inscribed within triangle object 515, and circle object 517 may circumscribe triangle object 515. In the tree 550, circle object 513 may be represented as node B1 and circle object 517 may be represented as node B2, since both objects may have been generated after triangle object 515 (e.g., node A) with respective dependencies (e.g., inscribing and circumscribing). Further, line object 519 may then be generated tangent to circle object 517 and represented as node C and dependent on node B2. These dependencies as represented by tree 551 may be locked as constraints between the shape objects in the drawing. If a user modifies the vertices of triangle object 515, as shown in drawing 514, the circle objects 513 and 517 and line object 519 may be modified concurrently to maintain the dependencies represented in tree 551.

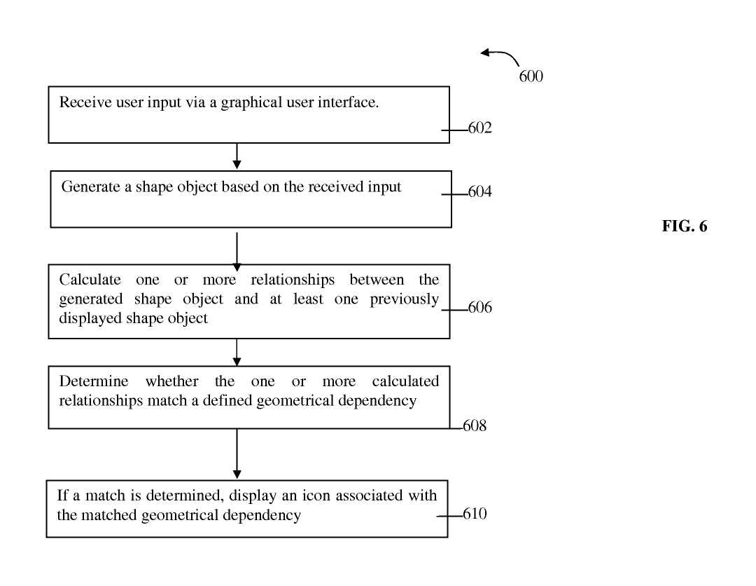

FIG. 6 is a flowchart of a method 600, according to embodiments of the invention. A computer system may define, by a processor (e.g., processor 105 in FIG. 1), one or more construction types or geometric dependences by a set of one or more relationships. A user may define a plurality of geometric dependencies, where each geometric dependency is associated with a set of relationships that describe common relationships used in geometry theorems.

In operation 602, the system may receive user input via a graphical user interface. A user may use an input device, such as a mouse or touch screen, and interact with a graphical user interface to select attributes of a set of points defining one or more shape objects. In operation 604, the processor may generate a new shape object based on the received input. The shape object may be a line, polygon, circle, or point, for example. In operation 606, one or more relationships may be calculated between the generated shape object and at least one existing or previously displayed shape object. Calculated relationships may be Boolean true or false values that indicate whether a condition is met or not met, for example, whether an intersection between shapes exists or whether shapes share a vertex. Calculated relationships may also be numerical values that describe a size ratio or an angle in degrees.

In operation 608, the processor may determine whether the one or more calculated relationships in the drawing match a defined geometrical dependency. The processor may determine a match within a proximity threshold, so that approximately drawn relationships between shapes may still match a defined geometrical dependency. For example, an angle of 87° drawn by a user may match a right angle dependency if the proximity threshold is set at ±5°. In operation 610, if a match is determined, an icon associated with the matched geometrical dependency may be displayed. The icon may suggest or infer a construction of the generated shape, relative to other existing shapes. The user may select the icon so that the generated shape is adjusted to the selected geometrical dependency.

Other or different operations may be performed.

While the invention has been described with respect to a limited number of embodiments, these should not be construed as limitations on the scope of the invention, but rather as exemplifications of some of the preferred embodiments. Other possible variations, modifications, and applications are also within the scope of the invention. Different embodiments are disclosed herein. Features of certain embodiments may be combined with features of other embodiments; thus certain embodiments may be combinations of features of multiple embodiments.

What is claimed is:

1. A computerized method for suggesting geometrical dependencies, comprising:
receiving user input via a graphical user interface;
generating, by a processor, a shape object based on the received input;
calculating, by the processor, one or more relationships between the generated shape object and at least one previously displayed shape object;
determining, by the processor, whether the one or more calculated relationships match a defined geometrical dependency; and
if a match is determined, displaying an icon associated with the matched geometrical dependency.

2. The method of claim 1, comprising:
upon selection by a user of the displayed icon, adjusting the generated shape object relative to the at least one previously displayed shape object, wherein relationships between the adjusted shape object and the previously displayed shape object match the defined geometrical dependency associated with the displayed icon.

3. The method of claim 2, comprising maintaining the matched geometrical dependency as constraints between the generated shape object and the at least one previously displayed shape object.

4. The method of claim 1, comprising defining a plurality of geometrical dependencies, wherein each geometrical dependency is defined by a respective set of one or more relationships and associated with a respective proximity

5. The method of claim 4, wherein determining whether the one or more calculated relationships match a defined geometrical dependency comprises determining whether the one or more calculated relationships match, within the respective proximity, a respective set of one or more relationships defining a geometrical dependency.

6. The method of claim 4, wherein if more than one match is determined, displaying an icon associated with one of the matching geometric dependencies based on a priority order.

7. The method of claim 1, wherein a relationship between a generated shape object and an existing shape object includes at least one of: an intersection of lines, an angle, and distance.

8. The method of claim 1, wherein a geometric dependency is at least one of:
parallel, perpendicular, tangent, congruent, inscribed, or circumscribed.

9. A non-transient computer readable medium containing program instructions that when executed by a computer processor cause the processor to perform a method of suggesting geometrical dependencies comprising:
generating a shape object based on input received from a user;
calculating one or more relationships between the generated shape object and at least one previously displayed shape object;
determining whether the one or more calculated relationships match a defined geometrical dependency; and
if a match is determined, displaying an icon associated with the matched geometrical dependency.

10. The non-transient computer readable medium of claim 9, wherein the program instructions when executed further cause the processor to:
upon selection of the displayed icon by a user, adjust the generated shape object relative to the at least one previously displayed shape object, wherein relationships between the adjusted shape object and the previously displayed shape object match the defined geometrical dependency associated with the displayed icon.

11. The non-transient computer readable medium of claim 10, wherein the program instructions when executed further cause the processor to:
maintain the matched geometrical dependency as constraints between the generated shape object and the at least one previously displayed shape object.

12. The non-transient computer readable medium of claim 9, wherein the program instructions when executed further cause the processor to:
define a plurality of geometrical dependencies, wherein each geometrical dependency is defined by a respective set of one or more relationships and associated with a respective proximity

13. The non-transient computer readable medium of claim 12, wherein the program instructions when executed further cause the processor to:
determine whether the one or more calculated relationships match a defined geometrical dependency by determining whether the one or more calculated relationships match, within the respective proximity, a respective set of one or more relationships defining a geometrical dependency.

14. The non-transient computer readable medium of claim 9, wherein if more than one match is determined, the processor is configured to display an icon associated with one of the matching geometric dependencies based on a priority order.

15. The non-transient computer readable medium of claim 12, wherein the program instructions when executed further cause the processor to, if more than one match is determined:
concurrently display icons associated with the matching geometric dependencies.

16. The non-transient computer readable medium of claim 9, wherein a geometric dependency is at least one of: parallel, perpendicular, tangent, congruent, inscribed, or circumscribed.

17. The non-transient computer readable medium of claim 9, wherein a relationship between a generated shape object and an existing shape object includes at least one of: an intersection of lines, an angle, and distance.

18. A device, comprising:
a memory to store a plurality of geometric dependencies, wherein each geometric dependency is defined by a set of relationships and associated with one or more proximity conditions;
a processor to:
receive input from a user via a graphical user interface;
generate a shape object in a drawing, based on the received input;
calculate one or more relationships between the generated shape object and at least one existing shape object within the drawing;
determine whether the one or more calculated relationships match one or more of the defined geometric dependencies within the associated proximity conditions; and
a display to:
display the drawing including the generated shape and the at least one existing shape object; and
display, within the drawing, an icon associated with at least one of the matching geometric dependencies.

19. The device of claim 18, wherein the processor is to:
allow selection of the displayed icon; and
adjust the generated shape object relative to the at least one existing shape object,
wherein relationships between the adjusted shape object and the existing shape object match the geometric dependency associated with the selected icon.

20. The device of claim 18, wherein the processor is to maintain the set of one or more relationships defining the selected geometric dependency as constraints between the generated shape object and the at least one existing shape object.
